(19) United States
(12) Patent Application Publication
(10) Pub. No.: US 2007/0291988 A1
(43) Pub. Date: Dec. 20, 2007

(54) METHOD AND DEVICE FOR PROTECTING PRODUCTS AGAINST COUNTERFEITING

(76) Inventors: MAXIM R. KARIMOV, Moscow (RU); MAXIM V. GRUZDEV, Moscow (RU)

Correspondence Address: BARDMESSER LAW GROUP, P.C., 910 17TH STREET, N.W., SUITE 800, WASHINGTON, DC, 20006, US

(21) Appl. No.: 11/835,932

(22) Filed: Aug. 8, 2007

Related U.S. Application Data
(63) Continuation-in-part of application No. PCT/RU06/00110, filed on Mar. 13, 2006.

(30) Foreign Application Priority Data
Mar. 18, 2005 (RU) 2005107647

(51) Int. Cl. G06K 9/00

(52) U.S. Cl. 382/103; 340/5.8; 235/375

(57) ABSTRACT

A method for protecting commercial goods against counterfeiting by detecting counterfeited goods that can be used by manufacturers for protection of their products and for protecting consumers from buying goods produced by illegal manufacturers. A three-dimensional identifier is affixed onto the product and an original digital image sample of the identifier is generated and stored in a database. The identifier is made of a transparent material with non-transparent particles distributed randomly throughout. A consumer, when purchasing the product can makes a digital picture of the product's identifier and sends it to the manufacturer or a third party. The manufacturer or a third party compares the digital picture received from the consumer with the original digital image sample stored in the database for authentication of the product.

### CROSS-REFERENCE TO RELATED APPLICATIONS

This patent application is a continuation-in-part of PCT application PCT/RU2006/000110 filed Mar. 13, 2006 and entitled COUNTERFEIT PROTECTING METHOD, which claims priority to Russian Patent Application No. 2005107647, filed Mar. 18, 2005, which are both incorporated herein by reference in their entirety.

### BACKGROUND OF THE INVENTION

1. Field of the Invention

The present invention relates generally to a method and device for protecting commercial goods from counterfeiting, and more particularly, to a method for detecting counterfeited goods that can be used by manufacturers for protection of their products and for protecting consumers from buying goods produced by illegal manufacturers and counterfeiters.

2. Background Art

A number of methods for protection of valuable paper products (i.e., documents) from counterfeiting are known. Typically, these methods employ special marks corresponding to a special identification code located in a dedicated area of a paper document. A microstructure of the dedicated area of the paper document is electronically scanned and parameters of an identification vector corresponding to the microstructure of this area are formed. The vector is converted into a protective code by using a cryptographic algorithm. The value of the protective code can be matched against the value of the special mark (see patent RU 2088971, issued on Aug. 27, 1997).

The above method increases effectiveness of protection of a valuable paper document against counterfeiting and reduces the costs associated with the protection of the paper documents. However, this method is based on employing a complex cryptographic algorithm, which makes it complicated and difficult to use. Therefore, the use of this method for protection of goods against counterfeiting is limited.

Another known method is directed to protection of goods against counterfeiting by detection of the counterfeit goods. The authenticity of goods is determined by comparison of a physical identifier affixed to a product with its image. The physical identifier contains optically detectable elements arranged in a random fashion. The optically detectable elements are natural properties of some materials having optical patterns. The physical patterns are compared with an image of the identifier (see patent RU 2202127, issued on Apr. 10, 2003). This method has the following shortfalls:

(a) low accuracy (reliability) of the results of the comparison procedure, due to the fact that a user has to visually compare two complex optical objects—a physical identifier and its image;

(b) complexity, difficulty, large number of procedures needed to be performed by a user as well as a length of time needed for determination of authenticity of the goods. The user has to determine the number of the identifier, send the identifier's number to the manufacturer, receive the image, visually compare two complex optical objects (the identifier and the image), analyze the results and make a decision regarding the degree of identity;

(c) inability to simplify the process and reduce the number of procedures the user is required to perform.

Another shortcoming of this method is inability to reduce the time needed for determining the authenticity of a product through automation due to the fact that certain procedures can not be automated. For example, a user has to determine the number of the identifier, to send this number to the manufacturer and to receive the image. Furthermore, the user has to perform procedures related to digitizing the identifier and in some instances employ software means for comparison.

Accordingly, there is a need for an efficient and convenient method for detecting counterfeit goods that can be used by manufacturers for protection of their products and for protecting consumers from buying goods produced by illegal manufacturers.

### SUMMARY OF THE INVENTION

The present invention relates generally to a method and device for protecting commercial goods from counterfeiting, and more particularly, to a method for detecting counterfeit goods that can be used by manufacturers for protection of their products and for protecting consumers from buying goods produced by illegal manufacturers, that substantially obviates one or more of the disadvantages of the related art.

According to one embodiment of the present invention, a highly reliable and convenient method for determining authenticity of goods and products is provided. The proposed method effectively protects consumers and manufacturers against counterfeiting. This goal is accomplished by determining an authenticity of a product by comparison of a digital image (or a representation of the digital image containing relevant information) of a physical identifier affixed to the product with an original digital image of this identifier generated by the manufacturer at a time of production. The physical identifier is implemented in a form of at least partrially transparent, or fully transparent, multi-dimensional (three-dimensional) physical object containing randomly arranged optically visible elements. An original sample of a digital image of the identifier is stored in a database by manufacturer.

Product authenticity determination is realized through a verifying third party, which receives documents from a manufacturer, verifies the manufacturer's right to use the trademark and examines the reliability of the information provided to consumers by the manufacturer.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates one embodiment of the invention.

FIG. 2 illustrates a functional diagram of implementation of a method according to one embodiment of the invention.

FIG. 3 illustrates how a pharmaceutical blister pack can be used to detect counterfeiting, according to another embodiment of the invention.

### DETAILED DESCRIPTION OF THE PREFERRED EMBODIMENTS

Reference will now be made in detail to the embodiments of the present invention, examples of which are illustrated in the accompanying drawings.

The present invention is directed to a method and device for protecting commercial goods and products against counterfeiting. The proposed method for detecting counterfeit goods and products can be used by manufacturers for protection of their goods and products and for protecting consumers from buying goods and products produced by illegal manufacturers.

According to one embodiment of the present invention, a highly reliable and convenient method and device for determining authenticity of goods and products is provided. The proposed method effectively protects consumers and manufacturers against counterfeiting. The counterfeiting protection is accomplished by determining an authenticity of a product by comparison of a digital image of a physical three-dimensional identifier affixed to the product with an original digital image of this identifier generated by the manufacturer at the time of production. The physical identifier is implemented in a form of at least partially transparent three-dimensional physical object (as opposed to a two-dimensional label or similar) containing randomly arranged optically visible elements throughout the height width and length of the identifier. An original sample of a digital image of the identifier is stored in a database.

In one embodiment, each physical identifier has its own identification, for example, registration number that helps to determine which digital image sample from the plurality of digital samples stored in the database needs to be compared with the digital image of the physical identifier being examined. Here, the digital image can be a photograph-like image, a representation of the three-dimensional object that corresponds to the identifier, a two-dimensional projection of the three-dimensional object (or of the non-transparent elements) onto some hypothetical two-dimensional surface, or data corresponding to the locations and nature of the non-transparent elements (i.e., patterns formed by the non-transparent elements) or the like. Product authenticity determination can be accomplished through a verifying third party, which receives documents from a manufacturer, verifies the manufacturer's right to use the product's trademark and examines the reliability of the information provided to consumers by the manufacturer.

The three-dimensional physical object that serves as an identifier can be made out of transparent or partially transparent material containing randomly arranged non-transparent elements. Any visible particles can be used as the non-transparent elements. The visible particles can be of a random shape and of same or different colors and have same or different optical density. The visible particles can be statically located within the transparent three-dimensional object or can be dynamically randomly located (i.e., can change their positions) within the transparent three-dimensional object, when the filler substance of the three-dimensional object remains in a liquid or semi-liquid state.

The visible elements can be particles of the material with optical properties different from the optical property of the filler material of the three-dimensional object, such as, for example, randomly dispersed drops of the substrate of a different color (e.g., droplets of a dark-colored plastic distributed throughout a filler made of a light-colored or transparent plastic). The identifier can be implemented as a part of a label affixed onto the product or can be a part of the product itself or a part of the packaging (such as a bottle cap for a pharmaceutical package, or one of the units of pharmaceuticals in a blister pack or other standard packages) visible through the box and replaced with the identifier). The identifier can be affixed onto the product in such a way that it can not be removed and affixed onto another product without disturbing integrity of the identifier and/or integrity of the product itself.

The physical identifier has at least one visual property that makes it look similar to other identifiers and the similarity can be visually apparent when comparing different identifiers by a naked eye. The identifier can be produced by adding randomly shaped non-transparent particles into a transparent or partially transparent liquid substance. Then the liquid substance containing non-transparent particles is poured into a transparent container of a desired shape, where it hardens. The transparent container defines the shape and appearance of the identifier. Thus, the three-dimensional identifier is produced by placing the visible particles into transparent or partially transparent liquid glue-like (or similar) substance that is placed into the transparent container of a certain shape where the substance hardens over time, or is cured. Optionally, the hardened substance can be taken out of container and used as the identifier without a housing container.

In an alternative embodiment, the transparent substance remains inside the container in a liquid or semi-liquid state allowing the non-transparent particles to change their positions. In this embodiment, the comparison of images is more complex. It requires generation of special code values or descriptions of both of the digital images and comparison of the code values or descriptions. The code values or descriptions can contain information on a number of particles of each color and the comparison rules, such as, for example, the identifier should contain no more that n red particles, no more than m black and no more than p green particles, at least a total number q of particles, no more than a total number r of particles, etc. (Here, the colors are used for illustration only, since more accurate spectral comparisons can be performed). Comparison rules can also take in account the relative and absolute sizes of the particles (note that the particles can be the same size, or different sizes, the same color or different colors, the same material or different materials, and so on). The comparison rules can be made more or less complex depending on time allowed for product authentication.

In an alternative embodiment, multiple original images of the identifier can be provided for the identifiers with the liquid filler. The use of multiple images of the identifier ensures that when images of the identifier are taken, some particles blocked by other particles appear at least in one of the multiple images and are taken into account. For example a consumer at a point of sale may be required to move or shake the identifier a number of times and take a predetermined number of images. Thus, all the particles are taken into account and comparison is accurate.

When a product is authenticated, the digital image of the identifier is generated and transferred into the software application for digital comparison with the original digital image sample retrieved from the database. Generation and transfer of the digital image of the identifier can be performed by a device that has a functionality for image generation and data transfer, such as, for example a mobile phone with an integrated digital camera, or a webcam.

The proposed method for protection of goods and products against counterfeiting includes, but not limited to, the following steps:

providing the physical identifier (i.e. a protective element, a unique label or a physical mark) for a product, the identifier is made out of a transparent or partially transparent material containing randomly arranged optically visible elements;

generating a digital image of the identifier (original image sample);

placing the original image sample of the identifier into a database;

determining authenticity of the product by generating the digital image of the identifier affixed to (or associated with) the product and comparing the digital image of the identifier with the original digital image sample stored in the manufacturer's database. If the digital images match, the product is authentic, if they do not match, the counterfeited product is detected.

The proposed method provides the following advantages:

(a) high accuracy (reliability) of the results of comparison procedure;

(b) low number of the procedures performed by a consumer and minimal complexity of these procedures;

(c) ability to reduce the length of time needed for product authentication by automation of the comparison procedure.

One difference between the proposed method and the conventional methods is direct comparison of the original digital image of the identifier stored in the manufacturer's database with the digital image generated by the consumer. The direct comparison of digital images used in the preferred embodiment overcomes the shortcomings of the known methods discussed above by providing a very high level of protection of goods in combination with high reliability and convenience for consumers.

The protection of goods, provided by the proposed device and method, ensures that potential costs of production of a counterfeited identifier are much higher that the cost of production of the original identifier. Furthermore, the manufacturer conducts a complex and highly precise technical examination of authenticity of its own product, while the consumer is assured of authenticity of the product while being at the point of sale. The consumer does not need to use special equipment of any kind. All he has to do is to perform two very simple operations—take a picture and send an MMS message using his mobile phone. The time needed for determination of authenticity of the product does not exceed a few seconds.

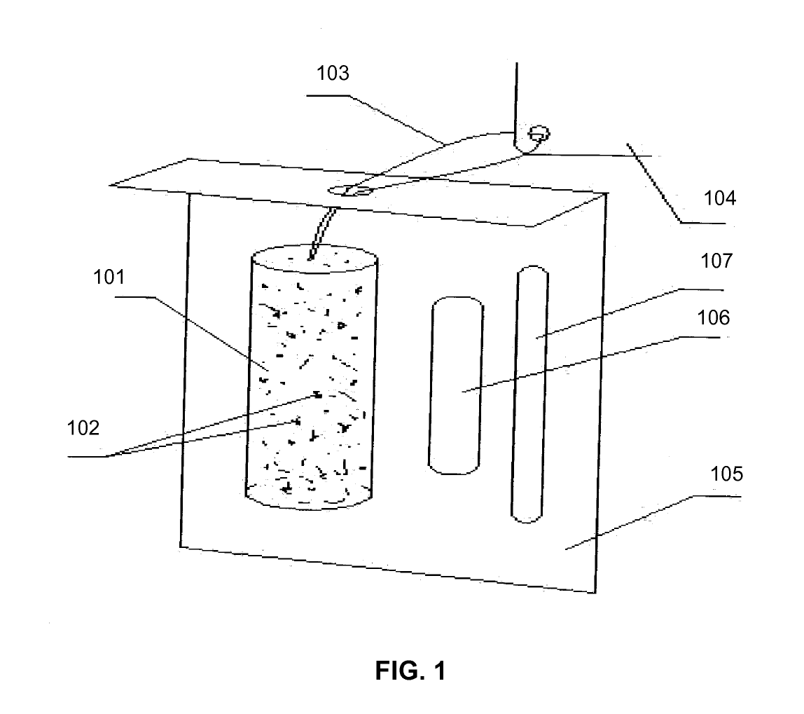

An example of an identifier attached to the product along with the label is shown in FIG. 1. The identifier 101 comprises a three-dimensional object made out of a transparent material, such as, for example, glass or plastic, that has a transparent hardened filler substrate inside. The transparent filler substrate has randomly placed hard particles 102 within it. The identifier 101 is attached to the product 104 by a thread 103 along with a label 105. The label 105 has a registration number 106 of the identifier 101 and an email address (or URL) 107 for sending the image written on the label 105.

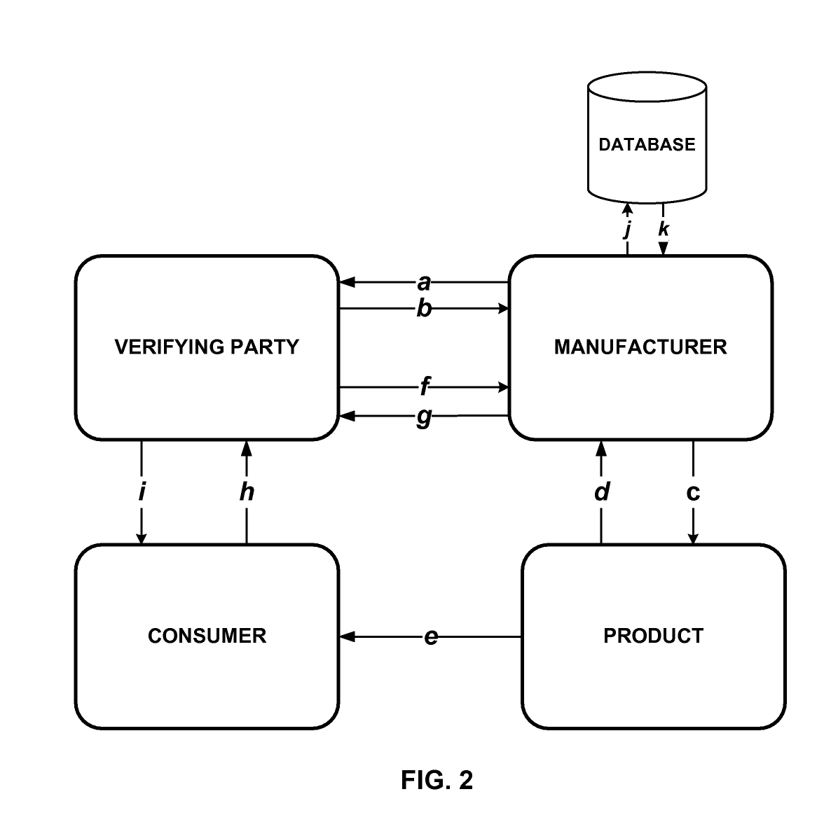

A functional diagram of implementation of a method of the invention is illustrated in FIG. 2. The operations performed for product authentication are marked by letters a-k. Product authentication is performed as follows. A verifying third party receives (a), from a manufacturer, documents confirming the manufacturer's right to use the product's trademark and passes on (b) to the manufacturer identifier's registration number. The manufacturer produces and attaches (c) the identifier to the product along with the label, which has identifier registration number written on it. The manufacturer generates a digital image of the identifier (d) and stores (j) it in the database along with its registration number and description of the product.

A consumer, at a point of sale, using his mobile phone with an integrated digital camera (or a webcam, or a scanner), produces (e) the digital image of the attached identifier and its registration number. Then the consumer sends (h) the digital image to a third party verifier, who identifies the identifier's registered number on the image and sends (f) the image produced by the consumer to the manufacturer. The manufacturer, based on the identifier's registered number, finds the original image sample of the identifier in the database (k) and compares it with the image produced by the consumer. Then the manufacturer sends (g) the results of comparison to the verifying third party, who informs (i) the consumer of the confirmed authenticity of the product or warns the consumer about the counterfeited product.

The positive result of comparison (i.e., positive authentication) is finalized by sending to the consumer confirmation of the product authenticity, including product description and confirmation of manufacturer's right to use the product trademark.

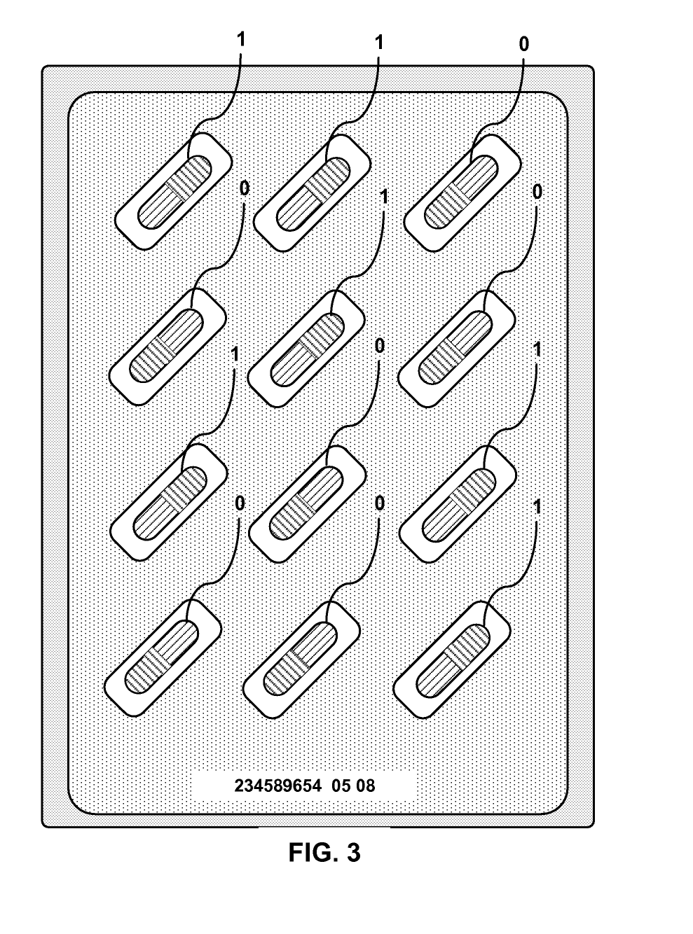

FIG. 3 illustrates how a pharmaceutical blister pack can be used to detect counterfeiting, according to another embodiment of the invention. Here, the blister pack is shown having an identification number on the bottom of the package (which is typically unique for each pack), and the capsules are two-color (e.g., black/white, black/red, red/white, black/yellow, etc.), with the colors shown. Generally, when each pack is manufactured, the orientation of each capsule is random. Each orientation can be assigned a binary value (0 or 1), and the orientation of the capsules in the entire pack can be represented by a binary number, in this illustration, 110010101001. In this illustration, there are 12 capsules, giving 2¹², or 4096 possible binary values that can be associated with the pack's identification number, here, 234589654. In order to make a counterfeit blister pack to match the same identification number 234589654, a counterfeiter would need to manually insert each capsule in the proper orientation—in exactly the orientations as would be required by the binary number 110010101001. This is laborious and time consuming, and does not easily lend itself to automation. Further, if a manufacturer or a third party verifying entity notices that too many “hits” are being received for a particular pack's identification number and the same binary number (even a correct binary number), this would trigger a red flag that that particular pack has been counterfeited, and the pack's identification number can be removed from the database, resulting in a verdict of “counterfeited” to the user.

Having thus described the different embodiments of a system and method, it should be apparent to those skilled in the art that certain advantages of the described method and system have been achieved. In particular, it should be appreciated by those skilled in the art that method described in the preferred embodiment provides a consumer with a very simple and yet reliable method of authenticating the product before finalizing a purchase.

It should also be appreciated that various modifications, adaptations, and alternative embodiments thereof may be made within the scope and spirit of the present invention. The invention is further defined by the following claims.

What is claimed is:

1. A method for protection of products against counterfeiting, the method comprising:
affixing a three-dimensional identifier to a product, the identifier comprising a plurality of randomly positioned visible elements;
generating an original digital image of the identifier;
storing a representation of the original digital image of the identifier in a database;
generating second digital image of the identifier;
comparing the representation of the second digital image with the representation of the original digital image retrieved from the database;
determining authenticity of the product based on result of comparison; and
providing a result of the comparison to a user.

2. The method of claim 1, wherein the identifier further comprises a filler in which the particles are positioned, the filler being at least partially transparent.

3. The method of claim 1, wherein the identifier further comprises a filler in which the particles are positioned, the filler being a liquid, and wherein positions of the visible elements within the filler can change.

4. The method of claim 3, wherein code values of the representations of the original image and the second image are generated and compared.

5. The method of claim 4, wherein the code values are formed based on comparison rules.

6. The method of claim 5, wherein the comparison rules refer to properties of the visible elements, the properties including any of:
an absolute size;
a relative size;
a relative position;
a color; and
an optical density.

7. The method of claim 1, wherein the identifier has a unique registration number.

8. The method of claim 7, wherein the registration number is written on a label affixed to the product.

9. The method of claim 7, wherein the registration number is sent to the manufacturer together with the digital image of the identifier.

10. The method of claim 7, wherein the original digital image is retrieved from the database based on the identifier's registration number.

11. The method of claim 1, wherein the determination of the authenticity is performed through a verifying third party.

12. The method of claim 11, wherein the verifying third party examines the manufacturer's rights to use the product's trademark and confirms information provided to a consumer by the manufacturer.

13. The method of claim 1, wherein removal of the identifier from the product causes the identifier's integrity to be destroyed.

14. The method of claim 1, wherein removal of the identifier from the product causes the product's integrity to be destroyed.

15. The method of claim 1, wherein the visible elements are non-transparent.

16. The method of claim 1, further comprising sending a representation of the second digital image of the identifier to a verifying entity for comparison.

17. A method for production of an anti-counterfeiting identifier, the method comprising:
providing a liquid filler substrate;
providing a transparent container;
providing particles of a hard and at least partially non-transparent substance;
producing a suspension by adding the particles into the liquid filler substrate; and
filling the transparent container with the suspension; and hardening the suspension.

18. The method of claim 17, wherein the shape of the product identifier matches a shape of the transparent container.

19. The method of claim 17, wherein the particles have random shapes.

20. An anti-counterfeiting product identifier, comprising:
a method for protection of products against counterfeiting, the method comprising:
filling a transparent container with a filler substrate formed of a plastic of a first color;
randomly distributing a plastic of a second color throughout the filler substrate so as to form a random pattern, to thereby form a three-dimensional identifier;
affixing the three-dimensional identifier to a product;
generating an original digital image of the identifier;
storing a representation of the original digital image of the identifier in a database;
generating second digital image of the identifier;
comparing the representation of the second digital image with the representation of the original digital image retrieved from the database;
determining authenticity of the product based on result of comparison; and
providing a result of the comparison to a user.

21. The anti-counterfeiting product identifier of claim 20, wherein the identifier is a part of the product packaging.

22. The anti-counterfeiting product identifier of claim 20, wherein the identifier is a part of the product label.

23. A method for protection of products against counterfeiting, the method comprising:
generating an original digital image of a blister pack containing two-color capsules;
storing a binary value corresponding to orientations of the capsules and an associated identification number of the blister pack;
generating second digital image of the blister pack;
comparing the binary value corresponding to the orientation of the capsules in the second digital image and the identification number of the blister pack in the second digital image with the stored binary value and the stored associated identification number;
determining authenticity of the blister pack based on result of comparison; and
providing a result of the comparison to a user.
